(19) United States
(12) Patent Application Publication
(10) Pub. No.: US 2015/0128704 A1
(43) Pub. Date: May 14, 2015

(54) ARRANGEMENT FOR MONITORING A STRUCTURAL COMPONENT WHICH ROTATES ABOUT ITS AXIS

(71) Applicant: NEXANS, Paris (FR)

(72) Inventors: Richard Riedel, Floss (DE); Dietmar Volkl, Ploessberg (DE); Norbert Bock, Kemnath (DE)

(21) Appl. No.: 14/532,077

(22) Filed: Nov. 4, 2014

(30) Foreign Application Priority Data
Nov. 8, 2013 (EP) 13 306 530.0

(51) Int. Cl. G01P 3/44

(52) U.S. Cl. CPC G01P 3/44
USPC 73/514.39

(57) ABSTRACT

An arrangement is provided for monitoring the rate of rotation of a structural component rotating about its axis and arranged in a motor vehicle in the immediate vicinity of the structural component. The speed sensor (11) is connected through an electrical line to an evaluating unit arranged in the motor vehicle, and the speed sensor (11) is connected together with a temperature sensor (12), which is also connected through an electrical line to an evaluating unit arranged in the motor vehicle, where the two sensors (11, 12) are arranged on a carrier of mechanically stable synthetic material which extends beyond the line.

### RELATED APPLICATION

This application claims the benefit of priority from European Patent Application No. 13 306 530.0, filed on Nov. 8, 2013, the entirety of which is incorporated by reference.

### BACKGROUND

1. Field of the Invention

The invention relates to an arrangement for monitoring the rate of rotation of a structural component which rotates about its axis and is arranged in a motor vehicle, wherein a speed sensor for determining the rate of rotation of the component is mounted in the immediate vicinity which is connected through an electrical line to an evaluating unit arranged in the motor vehicle.

2. Description of Related Art

Such an arrangement is employed in modern motor vehicles, called “vehicles” for short, in order to be able to, for example, monitor the rate of rotation of gear unit wheels. The same is particularly true for motor vehicles with automatically operating gear units in which a precise indication of the actual rate of rotation of the gear wheels is required for switching into another gear stage. In addition, in known technology, monitoring of the rate of rotation of the wheels in the ABS systems of motor vehicles is required in order to prevent, if necessary, a complete standstill of the wheels. In particular in automatically operating gear units, the temperature prevailing in the gear unit is advantageously monitored. For this purpose, a temperature sensor which is independent of the speed sensor is used, wherein, the temperature sensor must be mounted separately.

### Objects and Summary

The invention is based on the object of constructing the above described arrangement in such a way that, in addition to the rate of rotation of a structural component, also the temperature in the vicinity thereof can be monitored in a simple manner.

In accordance with the invention, this object is met in that
the speed sensor, together with a temperature sensor, which is also connected through an electrical line to an evaluating unit, is arranged on a carrier of mechanically stable synthetic material in the motor vehicle, and
the two sensors, including the carrier supporting the sensors, are embedded in a protective body manufactured by injection molding which extends beyond the line.

This arrangement composed of two sensors having different functions can be easily mounted because, for monitoring the rate of rotation on the one hand, and the temperature on the other hand, only a single piece combined sensor element has to be arranged in the area of the structural component to be monitored. In addition, the sensors are embedded in a moisture tight manner in such a way that they survive rough conditions without damage as they occur during the operation of vehicles.

In accordance with a preferred embodiment, a capacitor is connected parallel to the speed sensor as an EMV protection which also is embedded in the protective body.

Advantageously, mounted on and projecting from the protective body is a fastening element through which it can be ensured that the speed sensor, for example and preferably a semi-conductor, can be mounted correctly with respect to its position in such a way that it always delivers problem free measurement values.

### BRIEF DESCRIPTION OF THE DRAWINGS

An embodiment of the invention is illustrated in the drawings.

In the drawing:

FIGS. 1 and 2 show the arrangement according to the invention in two different views.

FIG. 3 shows an enlarged illustration of the individual components of the arrangement on a larger scale.

FIGS. 4 and 5 show a detail of the arrangement on a once again further reduced scale.

### DETAILED DESCRIPTION

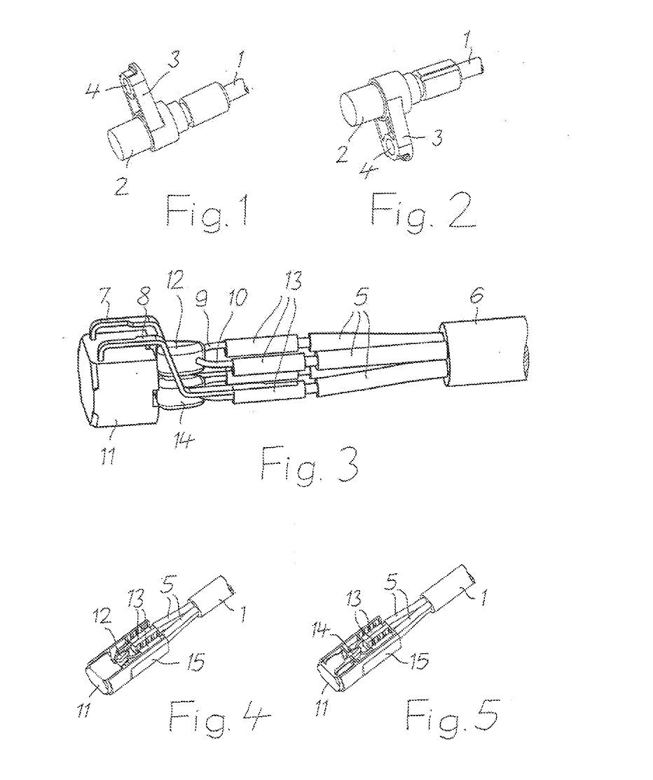

FIGS. 1 and 2 of the drawing show the finished arrangement according to the invention in two different perspective views in which the individual parts of the arrangement and the end of an electrical conductor 1 are surrounded by a protective body 2 manufactured by injection molding. The protective body 2 consists, for example, of polyamide or polybutylene terephthalate (PET) in the illustrated embodiment. It includes a fastening element 3 used for the correct positioning of the arrangement at the place of installation. For this purpose, it may be provided with a throughhole 4.

The line 1 is, for example, a four strand electrical line in which four strands 5 are arranged, which are surrounded by a common casing 6 of insulation material which is composed, for example, of polyurethane. Each strand 5 has an electric conductor, preferably a copper conductor, wherein each conductor is surrounded by an insulation of polyurethane or polyethylene. The conductors are referred to by reference numerals 7, 8, 9 and 10. In accordance with FIG. 3, a speed sensor 11 is electrically conductively connected to the conductors 7 and 8. A temperature sensor 12 is electrically conductively connected to the conductors 9 and 10. The respective electrical connection points are located in strand end sleeves 13. They consist of metal, such as for example, brass or a brass alloy.

Advantageously, a Hall sensor is used as the speed sensor 11 which reacts to a change of the magnetic field acting on it. The temperature sensor 12 advantageously is an electrical resistance with a negative temperature coefficient, a so called NTC resistor. In a preferred embodiment, a capacitor 14 is connected to the conductors 7 and 8 which serves as a protection of the arrangement relative to the electromagnetic fields.

In accordance with FIGS. 4 and 5, a carrier 15, constructed approximately as a rectangular structural component, wherein the carrier 15 is composed of a mechanically stable insulating material, for example PA or PBT. The carrier 15 has indentations or recesses for receiving the individual components illustrated in FIG. 3 and described herein above.

The manufacture of the arrangement according to the invention is carried out, for example, as follows:

The case 6 is removed from the end of the four strand electrical line 1, so that the strands 5 are exposed. Subsequently or simultaneously the insulation is removed from the ends of the strands 5, so that the conductors 7 to 10 are available for effecting the electrical connection to the two sensors 11 and 12. Subsequently, the respective electrical connections are prepared, wherein each of the connections is arranged at one of the strand end sleeves 13. In so doing, the speed sensor 11 is connected to the conductors 7 and 8, while the temperature sensor 12 is connected to the conductors 9 and 10. In a preferred embodiment, the capacitor 14 is also connected at the conductors 7 and 8 parallel to the speed sensor 11.

Subsequently, the end of the line 1, prepared or equipped in the manner described above, is mounted at the end of the carrier 15. In accordance with FIGS. 4 and 5, the speed sensor 11 is placed in an outwardly open recess at an end face of the carrier 15. The temperature sensor 12 (FIG. 4) and the capacitor 14 (FIG. 5) are also placed in the recesses of the carrier 15. Consequently, the speed sensor 11 rests against the free end face of the carrier 15, while the line 1 with the strands 5 are placed in recesses of the carrier 15, just like the strand end sleeves 13.

Finally the carrier 15, including the strands 5 and the end of the line 1, equipped in the described manner, is subsequently placed in an injection molding tool in which the protective body 2 is injection molded around the arrangement in such a way that the speed sensor 11 is covered by a thin layer which is, for example, 0.5 mm. The layer is dimensioned in such a way that the speed sensor 11 is also closed in a moisture tight manner without impairing its function. The protective body 2 protrudes beyond the case 6 of the line 1 so that the arrangement is embedded in a moisture tight manner.

1. Arrangement for monitoring the rate of rotation of a structural component which rotates about its axis, said arrangement comprising:
a speed sensor for determining the rate of rotation mounted in the immediate vicinity of the structural component; and
an electrical line arranged in the motor vehicle and connected to an evaluating unit,
wherein speed sensor, together with a temperature sensor which is also connected Lo an evaluating unit, is mounted on a support of mechanically stable synthetic material, and
wherein the two sensors are embedded, including the support, in a protective body of insulating material which extends beyond the line.

2. Arrangement according to claim 1, wherein, parallel to the speed sensor, a capacitor is connected to the electrical line thereof which is also embedded in the protective body.

3. Arrangement according to claim 1, wherein the protective body has a fastening element protruding from the same for the positionally correct mounting of the arrangement.
